(19) United States
(12) Patent Application Publication
(10) Pub. No.: US 2016/0171308 A1
(43) Pub. Date: Jun. 16, 2016

(54) ELECTRONIC DEVICE AND IMAGE PROCESSING METHOD

(71) Applicants: Kabushiki Kaisha Toshiba, Tokyo (JP); Toshiba Lifestyle Products & Services Corporation, Tokyo (JP)

(72) Inventor: Noriaki Kawai, Fussa Tokyo (JP)

(21) Appl. No.: 14/940,610

(22) Filed: Nov. 13, 2015

Related U.S. Application Data
(60) Provisional application No. 62/092,068, filed on Dec. 15, 2014.

(51) Int. Cl. G06K 9/00; G06K 9/52; G06T 7/00; G06T 7/60; H04N 5/262; H04N 5/76

(52) U.S. Cl. CPC G06K 9/00744; H04N 5/2628; H04N 5/76; G06T 7/0042; G06T 7/602; G06K 9/52

(57) ABSTRACT

According to one embodiment, an electronic device including, object determination module extracts and records feature pattern of object in video displayed on the display unit in response to input of instruction, position specification module specifies position of object in each video frame based on recorded feature pattern, area determination module determines area including object, position determination module determines position at which enlarged image of area is displayed outside area determined by area determination module based on position specified by position specification module, and enlargement module generates and outputs signal of enlarged image.

### CROSS-REFERENCE TO RELATED APPLICATIONS

This application claims the benefit of U.S. Provisional Application No. 62/092,068, filed Dec. 15, 2014, the entire contents of which are incorporated herein by reference.

### FIELD

Embodiments described herein relate generally to an electronic device and an image processing method.

### BACKGROUND

Recently, an image display device capable of enlarging and displaying an object designated on a display screen while automatically following the object is known.

However, the above image display device has a problem that video around the periphery of the object cannot be viewed since the enlarged display of the object is superimposed on the object and displayed.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 shows an example of a configuration example of an electronic device according to an embodiment;

FIG. 2 shows an example of a display screen on which a circular area including an object is enlarged and displayed according to the embodiment;

FIG. 3 shows an example of a positional relationship between the object and an enlarged image displayed on the display screen according to the embodiment;

FIG. 4 shows an example of a flow of signal processing from receiving an instruction to enlarge and display the object to superimposing the enlarged image on original video according to the embodiment;

FIG. 5 shows an example of a configuration example of an electronic device according to the embodiment;

FIG. 6 shows an example of a display screen on which two objects and enlarged images of the objects are displayed at the same time according to the embodiment;

FIG. 7 shows an example of a state where an area including the object is enlarged in two steps and displayed on the display screen according to the embodiment;

FIG. 8 shows an example of a state where the display screen is divided into five areas according to the embodiment; and

FIG. 9 shows an example of a mobile device comprising a button and a display screen equipped with a touch panel according to the embodiment.

### DETAILED DESCRIPTION

Various embodiments will be described hereinafter with reference to the accompanying drawings.

In general, according to one embodiment, an electronic device comprising: a receiver which receives input of an instruction to display an enlarged image of an area including a desired object on a display unit; an object determination module which extracts and records a feature pattern of the object in video displayed on the display unit in response to the input of the instruction; a position specification module which specifies a position of the object in each video frame based on the recorded feature pattern; an area determination module which determines the area including the object; a position determination module which determines a position at which the enlarged image of the area is displayed outside the area determined by the area determination module based on the position specified by the position specification module; and an enlargement module which generates and outputs a signal of the enlarged image.

Embodiments will now be described hereinafter in detail with reference to the accompanying drawings.

### First Embodiment

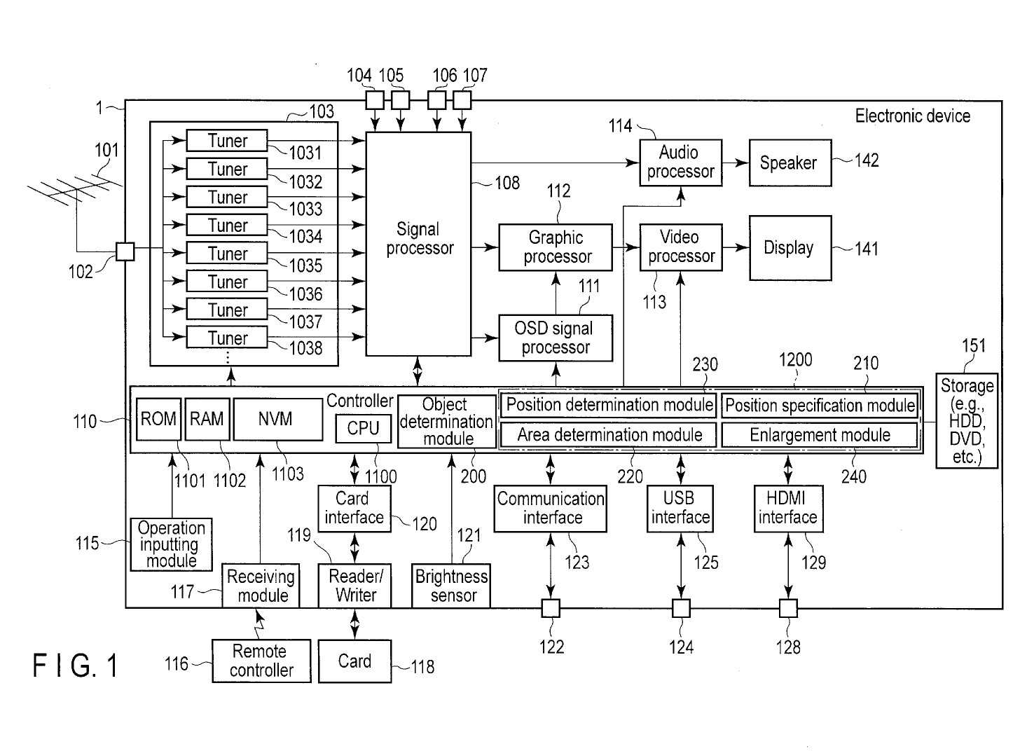

FIG. 1 is a diagram showing a configuration of an electronic device 1 of a first embodiment.

As shown in FIG. 1, the electronic device 1 of the first embodiment comprises an antenna 101, an input terminal 102, a tuner module 103, external input terminals 104 to 107, a signal processor 108, a controller 110, an on-screen display (OSD) signal processor 111, a graphic processor 112, a video processor 113, an audio processor 114, an operation inputting module 115, a receiving module 117, a reader/writer 119, a card interface 120, a brightness sensor 121, a LAN terminal 122, a communication interface 123, a USB terminal 124, a USB interface 125, an HDMI (registered trademark) terminal 128, an HDMI interface 129, a display 141, a speaker 142 and a storage 151. The above modules are each configured as a hardware circuit and are connected via electrical signal lines such as a leased line or a general-purpose communication bus.

The tuner module 103 comprises tuners 1031 to 1038 for terrestrial digital television broadcasting, and further comprises tuners for BS/CS digital television broadcasting. A program guide corresponding to the terrestrial digital television broadcasting can be received and displayed by the tuners 1031 to 1038 for the terrestrial digital television broadcasting. A program guide corresponding to the BS/CS digital television broadcasting can also be received and displayed by the tuners for the BS/CS digital television broadcasting.

In the present embodiment, the electronic device 1 comprises the display 141 and the speaker 142 as shown in FIG. 1. However, the electronic device 1 is not limited to such a configuration. For example, the electronic device 1 may have a configuration excluding the display 141 and the speaker 142. That is, the electronic device 1 may be connected to the display 141 and the speaker 142 via connecting means such as an HDMI.

In the present embodiment, the electronic device 1 comprises the storage 151 as shown in FIG. 1. However, the electronic device 1 is not limited to such a configuration. For example, the electronic device 1 may have a configuration excluding the storage 151. That is, the electronic device 1 may be connected to an external storage device (HDD, etc.) via connecting means such as the USB terminal 124 and the USB interface 125.

In the present embodiment, the electronic device 1 comprises the plurality of tuners as shown in FIG. 1. However, the electronic device 1 is not limited to such a configuration. For example, the electronic device 1 may have a configuration excluding the plurality of tuners. In this case, for example, the electronic device 1 may receive Internet Protocol (IP) broadcasting via the LAN terminal 122 and reproduce and record programs corresponding to a plurality of channels of the IP broadcasting.

The electronic device 1 is hereinafter described in detail.

Terrestrial digital television broadcasting signals received by the antenna 101 for receiving the terrestrial broadcasting are supplied to the tuners 1031 to 1038 via the input terminal 102, and digital television broadcasting signals of desired channels are selected by signal processors for the terrestrial digital television broadcasting of the tuners 1031 to 1038. Then, the digital television broadcasting signals selected by the tuners 1031 to 1038 are supplied to the signal processor 108 and demodulated into digital video signals and digital audio signals.

The signal processor 108 selectively executes predetermined digital signal processing for the digital video signals and the digital audio signals, and outputs the signals to the graphic processor 112 and the audio processor 114.

For example, the four input terminals 104 to 107 are connected to the signal processor 108. Each of the input terminals 104 to 107 allows analog video signals and analog audio signals to be input from the outside of the electronic device 1.

The signal processor 108 selectively digitizes the analog video signals and the analog audio signals supplied from each of the input terminals 104 to 107, executes predetermined digital signal processing for the digitized video signals and the digitized audio signals, and then outputs the signals to the graphic processor 112 and the audio processor 114.

The graphic processor 112 has a function of superimposing OSD signals processed in the OSD signal processor 111 on the digital video signals supplied from the signal processor 108 and outputting the signals. The graphic processor 112 can selectively output the output video signals of the signal processor 108 and the output OSD signals of the OSD signal processor 111. For example, the graphic processor 112 superimposes a video signal of an enlarged image to be described later on the digital video signals supplied from the signal processor 108.

The digital video signals output from the graphic processor 112 are supplied to the video processor 113. The video signals processed by the video processor 113 are supplied to the display 141. The display 141 displays an image based on the video signals.

The audio processor 114 converts the input digital audio signals into analog audio signals in a format reproducible by the speaker 142, and then outputs the converted signals to the speaker 142 to perform audio reproduction.

All the operations of the electronic device 1 including various reception operations described above are comprehensively controlled by the controller 110. The controller 110 comprises a central processing unit (CPU) 1100, etc. The controller 110 accepts operation information (various instructions) from the operation inputting module 115 or operation information (various instructions) received from a remote controller 116 via the receiving module 117, and controls each module, etc., such that the content of the operation is reflected on the control. The controller 110 also has a function of reproduction control of contents and controls content reproduction in accordance with the input operation information. The receiving module 117 and the remote controller 116 may transmit and receive operation signals by wireless communication using radio waves, etc., or may use infrared radiation.

The controller 110 comprises a read-only memory (ROM) 1101 which stores a control program executed by the CPU 1100, a random access memory (RAM) 1102 which provides the CPU 1100 with a work area, and a nonvolatile memory (NVM) 1103 to store various types of setting information, control information, etc. The ROM 1101, the RAM 1102 and the NVM 1103 are electrically connected to the CPU 1100. The RAM 1102 and/or the NVM 1103 store a feature pattern of an object to be described later.

The controller 110 further comprises an object determination module 200, a position specification module 210, an area determination module 220, a position determination module 230 and an enlargement module 240. These modules may be software modules executed by the CPU 1100 or hardware. The object determination module 200 extracts and records a feature pattern of an object in video displayed on the display unit. The position specification module 210 specifies a position of the object in each video frame based on the recorded feature pattern. The area determination module 220 determines an area including the object to be enlarged and displayed. The position determination module 230 determines a position at which an enlarged image of the object is displayed. The enlargement module 240 generates a video signal of the enlarged image of the object and transmits the signal to the OSD signal processor 111.

The controller 110 is connected to the reader/writer 119 to which a memory card 118 can be attached via the card interface 120. The controller 110 can thereby transmit information to and receive information from the memory card 118 attached to the reader/writer 119 via the card interface 120.

The controller 110 is also connected to the LAN terminal 122 via the communication interface 123. The controller 110 can thereby transmit information to and receive information from a LAN-compatible device connected to the LAN terminal 122 via the communication interface 123. In this case, the controller 110 has a Dynamic Host Configuration Protocol (DHCP) server function, and controls the LAN-compatible device connected to the LAN terminal 122 by assigning an IP address to the LAN-compatible device. A wireless LAN adapter or a LAN cable may be connected to the LAN terminal 122.

The electronic device 1 may be equipped with a wireless LAN adapter or communication equipment compatible with Bluetooth (registered trademark). The electronic device 1 can communicate with a server recording contents and a mobile device such as a smart phone and a tablet via the communication interface 123.

For example, the electronic device 1 can acquire information on a content recorded in another video receiver or recorder connected to the network or data on the content. For example, the electronic device 1 can transmit information on a content or data on the content recorded in the electronic device 1 to another video receiver or recorder connected to the network. The electronic device 1 of the first embodiment can select the other device (opposite device) to transmit the content recorded in the electronic device 1.

The controller 110 is also connected to the HDMI terminal 128 via the HDMI interface 129. The controller 110 can thereby transmit information to and receive information from an HDMI-compatible device connected to the HDMI terminal 128 via the HDMI interface 129.

The controller 110 is also connected to the USB terminal 124 via the USB interface 125. The controller 110 can thereby transmit information to and receive information from a USB-compatible device connected to the USB terminal 124 via the USB interface 125.

The controller 110 is configured to receive brightness detection signals from the brightness sensor 121. The controller 110 can control brightness, etc., of video and backlight based on the brightness detection signals.

The controller 110 can also control a recording operation to record broadcasting signals selected and descrambled by the tuner module 103 in the storage 151 or the external storage (HDD, etc.) connected via the LAN terminal 122 or the USB terminal 124. As described above, since the tuner module 103 comprises the plurality of tuners 1031 to 1038, the electronic device 1 can record and display programs of a plurality of channels at the same time. The electronic device 1 also has a function of authenticating scrambled broadcasting.

The above brief description relates to the configuration of the electronic device 1 of the embodiment. In the description below, the object determination module 200, the position specification module 210, the area determination module 220, the position determination module 230 and the enlargement module 240 that the controller 110 comprises are further described.

The object determination module 200 extracts and records a feature pattern of an object in video displayed on the display unit. For example, the object to be enlarged and displayed is designated as follows.

First, the user presses a predetermined key of the remote controller 116 and inputs an instruction signal to cause a pointer to be displayed on the screen. Next, the user moves the displayed pointer over the object and then presses an execute key.

If the display 141 comprises a touch panel, the object to be followed may be determined by touching the object on the touch panel or moving the finger around the object on the touch panel. The object may be specified by pronouncing a name of the object by the use of well-known voice recognition technology and image recognition technology. In this case, the electronic device 1 further comprises a microphone.

Following that, the object determination module 200 extracts a feature pattern of the object by the use of well-known image recognition technology. After extracting the feature pattern of the object, the object determination module 200 records the extracted feature pattern in, for example, the RAM 1102.

The position specification module 210 specifies a position of the object in each video frame based on the recorded feature pattern. In other words, the position specification module 210 specifies a position of the object exactly or substantially corresponding to the recorded feature pattern in each frame.

The position specification module 210 transmits positional information on the object in each frame to the position determination module 230. The positional information on the object is, for example, information on a central coordinate of the object or a central coordinate of an area including the object.

The area determination module 220 determines the area including the object. The area including the object is determined by, for example, using the recorded feature pattern of the object by a well-known method. The area including the object means an area including all or a part of the object.

The shape of the area including the object is, for example, a circle, a rectangle or an arbitrary shape predetermined by the user. If the shape of the area including the object is a rectangle, an aspect ratio may be determined based on the extracted feature pattern of the object. The shape of the area including the object may be a rectangle having the same aspect ratio as the display screen. If the enlarged image having a rectangular shape is displayed at the corner of the display screen, the four corners of the display screen can be used without any blank. The shape of the area is recorded in, for example, the NVM 1103.

The size of the area including the object may be constant or may be arbitrarily changed based on the extracted feature pattern of the object. If the object is larger than a predetermined size, the setting may be made so as not to execute the enlarged display.

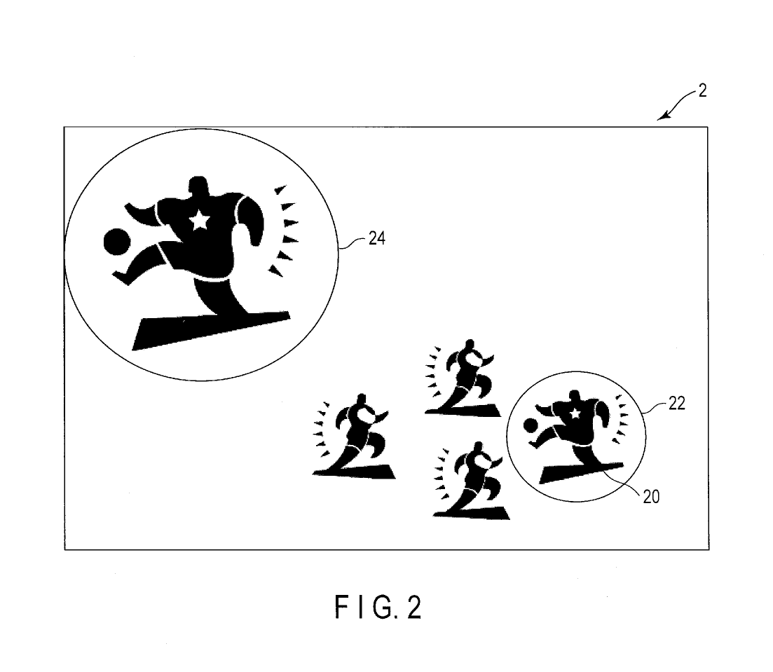

FIG. 2 shows an example of a display screen 2 on which a circular area including an object is enlarged and displayed. On the display screen 2, the object to be enlarged is a player 20 positioned at the lower right of the screen and an enlarged image 24 of a circular area 22 enclosing the player 20 is displayed at the upper left of the screen.

The position determination module 230 determines a position at which the enlarged image of the above area is displayed outside the area determined by the area determination module 220. For example, the position determination module 230 receives information on a central coordinate of the object to be enlarged and displayed or a central coordinate of the area including the object from the position specification module 210 and receives information on a preliminarily-registered enlargement ratio from the NVM 1103. Then, the display position of the enlarged image is determined based on the information on the central coordinate and the enlargement ratio.

For example, the following is one of specific methods for determining the display position of the enlarged image. The whole display screen is divided into four sub-screens 1 to 4, and which of these sub-screens includes the central coordinate of the object or the central coordinate of the area including the object is specified. Then, a sub-screen diagonally opposite from the sub-screen on which the central coordinate of the object or the central coordinate of the area including the object is positioned is determined as a sub-screen on which the enlarged image is displayed. On the sub-screen, the enlarged image may be displayed along the boundary of the display screen or displayed a predetermined pixel count distant from the boundary of the display screen.

In the above example, the enlarged image is displayed on the sub-screen diagonally opposite from the sub-screen on which the object is displayed. Therefore, the distance between the object and the enlarged image can become longer than the distance in the case of displaying the enlarged image on a sub-screen adjacent to the sub-screen on which the object is displayed. In particular, if the enlarged image is displayed at the corner of the display screen on the sub-screen diagonally opposite from the sub-screen on which the object is displayed, the distance between the object and the enlarged image becomes the longest.

It should be noted that “displaying the enlarged image on a certain sub-screen” means that the central coordinate of the enlarged object or the central coordinate of the enlarged area is positioned on the certain sub-screen and does not necessarily mean that the enlarged image is fitted within a sub-screen.

Another method for determining the display position of the enlarged image is a method referring to a look-up table in which the central coordinate of the object or the central coordinate of the area including the object is brought into correspondence with the display position of the enlarged image. The look-up table is recorded in the NVM 1103.

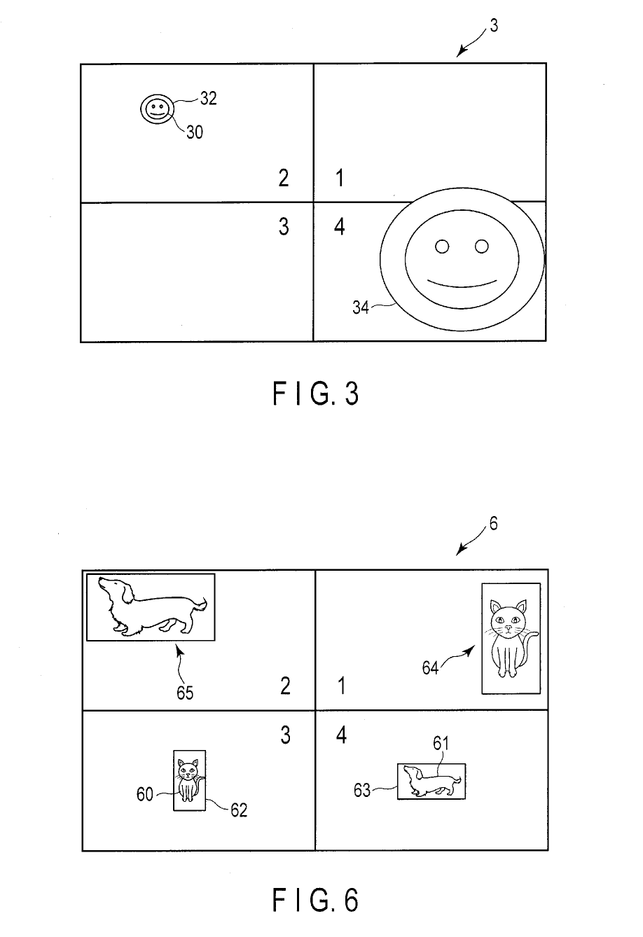

FIG. 3 is an illustration showing an example of a positional relationship between an object 30 and an enlarged image 34 displayed on a display screen 3. In FIG. 3, a circular area 32 including the object 30 displayed on a sub-screen 2 is enlarged and displayed on a sub-screen 4. In FIG. 3, the sub-screen 4 is diagonally opposite from the sub-screen 2. The enlarged image 34 is displayed over a sub-screen 3 and the sub-screen 4, but a central coordinate of the image 34 is positioned on the sub-screen 4.

The enlargement module 240 generates and outputs a signal of the enlarged image. More specifically, the enlargement module 240 enlarges the area including the object by a well-known method such as the bilinear method and generates a signal of the enlarged image. The generated signal of the enlarged image is input to the OSD signal processor 111 and superimposed on the original video together with the positional information determined by the position determination module 230. The enlargement ratio of the image may be a value pre-stored in the NVM 1103 or may be changed according to the size of the area including the object such that the enlarged image has a desired size.

The display of the enlarged image is finished by, for example, pressing a predetermined key of the remote controller 116 by the user. The enlarged display may be automatically finished along with disappearance of the feature pattern of the object from the frame. The end of the enlargement may be instructed with voice.

In the description below, the operation of the electronic device 1 comprising the above controller 110 is described.

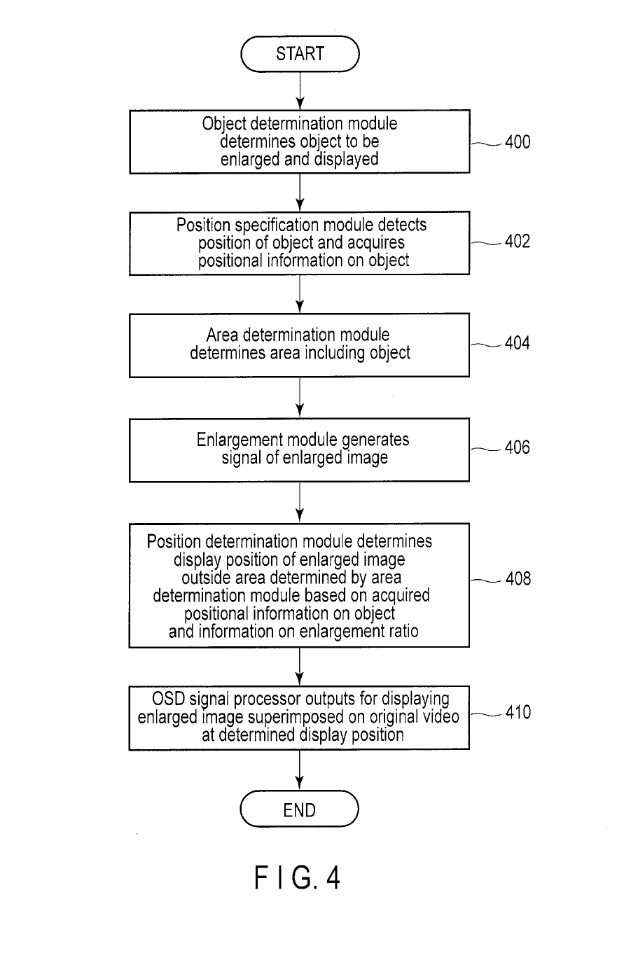

FIG. 4 is a flowchart showing a flow of signal processing from receiving an instruction to enlarge and display an object to superimposing an enlarged image on original video. The flow shown in FIG. 4 is hereinafter described.

First, the object determination module 200 determines an object to be enlarged and displayed [400]. The position specification module 210 detects a position of the object and acquires positional information on the object [402]. Next, the area determination module 220 determines an area including the object [404]. Then, the enlargement module 240 enlarges the area including the object and generates a signal of an enlarged image [406]. The position determination module 230 acquires the positional information on the object from the position specification module 210, acquires information on an enlargement ratio from the NVM 1103, and determines a position at which the enlarged image is displayed outside the area including the object [408]. Following that, the OSD signal processor 111 superimposes the enlarged image on original video and outputs for displaying enlarged image superimposed on original video at the display position determined by the position determination module 230 [410].

As described above, the electronic device of the embodiment can generate the enlarged image of the object included in the video and superimposes the enlarged image on the original video so as not to overlap the periphery of the object. Therefore, the electronic device of the embodiment allows the enlarged image of the object to be seen without hiding video around the periphery of the object.

### Second Embodiment

FIG. 5 is a diagram showing a configuration example of an electronic device of a second embodiment. The electronic device of the second embodiment is different from the electronic device of the first embodiment in that a frame memory 1104 is further comprised.

The frame memory 1104 can store the signal of the enlarged image generated by the enlargement module 240. A timing when the signal of the enlarged image stored in the frame memory 1104 is transmitted to the OSD signal processor 111 can be controlled by the CPU 1100.

More specifically, the CPU 1100 can adjust a time interval at which the signal of the enlarged image stored in the frame memory 1104 is output, and can keep the video of the enlarged image paused or slowly and sequentially reproduce the enlarged image. In other words, the original video may be normally reproduced or displayed as a program and the video of the enlarged image alone may be slowly and sequentially reproduced or paused.

The slowly and sequentially reproduction or the pause of the enlarged image is performed by, for example, continuously pressing the same key as the key of the remote controller 116 that gives an instruction to start enlargement of the object. In this case, the setting may be made such that the slowly reproduction or the pause is switched to the normal reproduction if pressing the key is stopped. The instruction to the slowly reproduce or pause the enlarged image may be issued by pressing a predetermined key of the remote controller 116.

A reproduction speed of the enlarged image can be preset by the user and recorded in, for example, the NVM 1103. The video of the enlarged image may be recorded in the storage 151 such as an HDD. The enlarged image can be thereby reproduced in response to the user's instruction after the reproduction of the original video is finished.

The electronic device of the second embodiment in which the above configuration is adopted can slowly reproduce, for example, an enlarged image of a fast-moving object. The electronic device of the second embodiment can also pause the enlarged image of the object. By using the function of pausing an enlarged image, for example, enlarged images of a figure and a formula can be displayed at the corner of the display screen in a moving image of a lecture to be distributed.

Similarly to the first embodiment, the electronic device of the second embodiment can also generate an enlarged image of an object included in video and superimpose the enlarged image on the original video such that the enlarged image does not overlap the periphery of the object. Therefore, the electronic device of the embodiment allows the enlarged image of the object to be seen without hiding the periphery of the object in the video.

For example, in the first and second embodiments, the same processing as the processing executed by the object determination module 200, the position specification module 210, the area determination module 220, the position determination module 230 and the enlargement module 240 may be executed by a sub-processor 1200. Two or more objects can be followed and enlarged images of these objects can be superimposed on the original video at the same time without delay of video display by comprising the sub-processor 1200 capable of executing the above signal processing at high speed and in parallel.

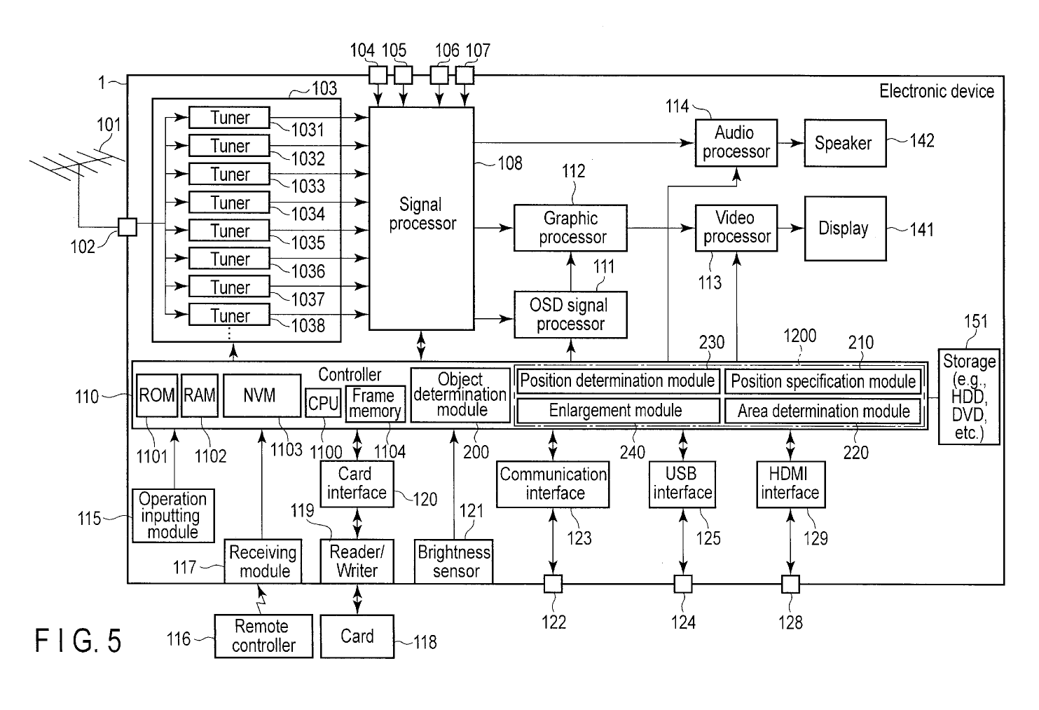

FIG. 6 is an illustration showing an example of a display screen on which two objects and enlarged images of these objects are displayed at the same time. In FIG. 6, a cat 60 which is a portrait-oriented object is displayed on a sub-screen 3 and a dog 61 which is a landscape-oriented object is displayed on a sub-screen 4. An area 62 enclosing the portrait-oriented cat 60 has a portrait-oriented rectangular shape and an area 63 enclosing the landscape-oriented dog 61 has a landscape-oriented rectangular shape. An enlarged image 64 of the area 62 enclosing the cat 60 is displayed on a sub-screen 1 and an enlarged image 66 of the area 63 enclosing the dog 61 is displayed on a sub-screen 2.

When two or more enlarged images are displayed at the same time and display positions of the enlarged images of different objects determined by the sub-processor 1200 (or the position determination module 230) are the same, an enlarged image of a first designated object is displayed with priority and a second enlarged image is displayed so as not to overlap the first enlarged image. For example, second and subsequent enlarged images may be sequentially arranged along the boundary of the display screen.

When second and subsequent objects to be enlarged are designated, a message may appear to inform the user that an enlarged image is already displayed. For example, a plurality of enlarged images being slowly reproduced or paused may be displayed by further comprising a plurality of frame memories 1104.

An enlarged image of an object may be displayed while gradually enlarged from a position at which the object is displayed to a position at which the enlarged image is displayed. In other words, a plurality of enlarged images different in enlargement ratio may be sequentially displayed from the display position of the object to the display position of the enlarged image determined by the position determination module 230.

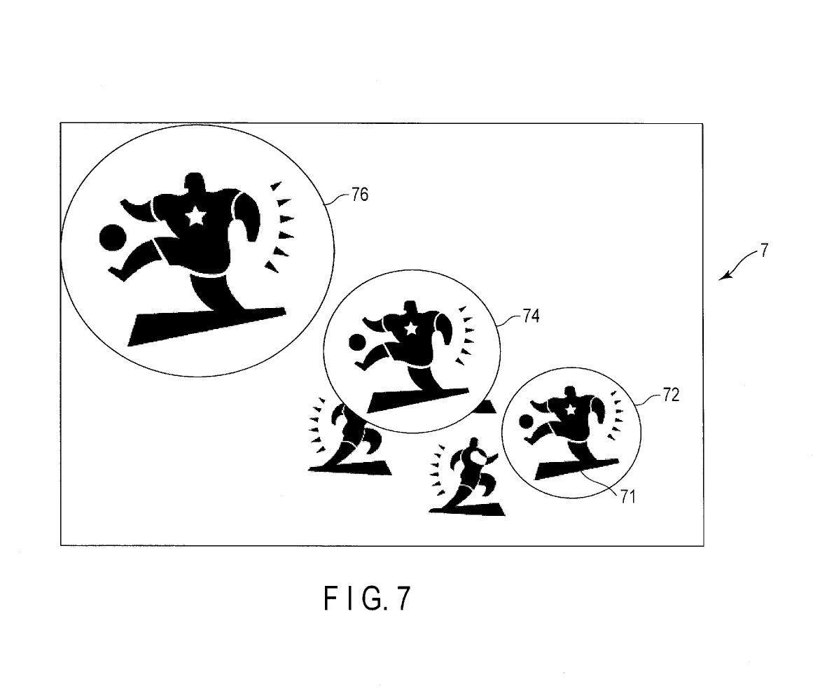

FIG. 7 is an illustration showing a state where an area including an object is enlarged in two steps and displayed on a display screen 7. A soccer player 71 which is an object to be enlarged is displayed at the lower right of the display screen 7.

First, a middle enlarged image 74 is obtained by enlarging an area 72 including the soccer player 71 at an enlargement ratio lower than a preset enlargement ratio. For example, the middle enlarged image 74 is displayed at an intermediate position between the position determined by the position determination module 230 and the central coordinate of the object to be enlarged. Then, a final enlarged image 76 obtained by enlarging the area at the preset enlargement ratio is displayed at the position determined by the position determination module 230.

If the object is enlarged in two steps as described above, a position on the display screen at which the enlarged image of the object is displayed can be easily seen. Therefore, the user can easily understand the display position of the enlarged image. Instead of the middle enlarged image 74, an arrow pointing the display position determined by the position determination module 230 from the display position of the object may be displayed.

The setting may be made such that the display position of the enlarged image is fixed without change or the enlarged image is not displayed if the object is displayed at a predetermined position on the display screen. The position determined by the position determination module 230 (i.e., the display position of the enlarged image) can be thereby prevented from being frequently changed, for example, when the object moves near the center of the screen. Instead, the setting may be made such that the display position of the enlarged image is not changed for a predetermined time after the object moves from a sub-screen to another sub-screen.

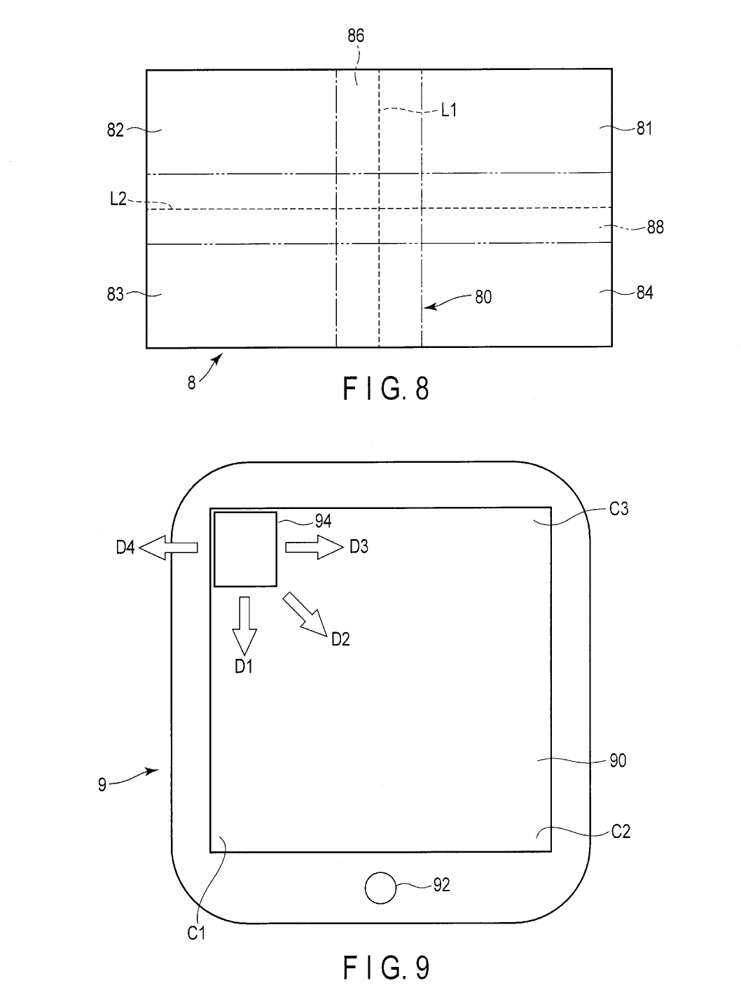

FIG. 8 is an illustration showing a state where a display screen 8 is divided into five areas. In FIG. 8, a cross-shaped area 80 is obtained by combining two strip-shaped areas 86 and 88. A central line L1 in the longitudinal direction of the strip-shaped area 86 corresponds to a central line L1 in the shorter side direction of the display screen 8. A central line L2 in the longitudinal direction of the strip-shaped area 88 corresponds to a central line L2 in the longitudinal direction of the display screen 8. A length in the shorter side direction of the strip-shaped area 86 is, for example, a fifth, a quarter, a third or a half of a length in the longitudinal direction of the display screen 8. A length in the shorter side direction of the strip-shaped area 88 is, for example, a fifth, a quarter, a third or a half of a length in the shorter side direction of the display screen 8.

For example, if the object moves in the area 80, the display position of the enlarged image is not changed. For example, when the object moves from any one of the four areas 81 to 84 to another one of these areas, the display position of the enlarged image is changed.

The display position of the enlarged image may be determined based on a history of the user's observation. For example, in a video receiver or a mobile device such as a tablet or a smart phone equipped with an imaging element, a display screen is divided into a plurality of sections and a frequency or a total time of the user's observation of each section is recorded whenever the user watches video. Then, the enlarged image is displayed in a section having the lowest frequency or the shortest total time of the user's observation. A measurement period of the frequency or the total time is, for example, a day, a week or a month.

The enlarged image may be determined to be displayed at a position judged as a background in a video displayed on the display screen by the use of well-known image recognition technology.

If the display 141 comprises a touch panel, the setting may be made such that the position of the displayed enlarged image is moved to another position or the display of the enlarged image is finished by a flick. This case is hereinafter described with reference to FIG. 9.

FIG. 9 is an illustration showing a mobile device 9 comprising a display screen 90 equipped with a touch panel and a button 92. In FIG. 9, an enlarged image 94 is displayed at the upper left of the display screen 90. The enlarged image may be moved to positions C1 to C3 by a flick in the directions of D1 to D3. The display of the enlarged image may be finished by a flick in the direction of D4.

If data of received television broadcasting is displayed, a high priority may be given to display of OSD signals included in broadcasting data such as time information, weather information and program information such that the enlarged image does not overlap the display position of the broadcasting data.

If the focus of a lens of a camera is adjusted to the object during imaging and the object in a frame is enlarged, the display of the enlarged image may be finished. For example, the display of the enlarged image may be finished if the feature pattern of the object becomes larger than a predetermined enlargement ratio in comparison with the feature pattern of the object first extracted by the object determination module 200.

The video of the enlarged image alone may be recorded in the storage 151 such as an HDD to reproduce the enlarged image alone later. The recorded video of the enlarged image may be transmitted to an external device such as a smart phone, a tablet or a personal computer via the communication interface 123.

The accuracy of following the object may be improved by recognizing the object displayed in a program from program information included in a transport stream (TS) and preliminarily collecting the feature pattern of the object from image data on the Internet.

The embodiments are described by taking a television receiver as an example. However, the above-described image processing method can also be applied in a case of displaying video data other than broadcasting data in other video processing devices. For example, the image processing method can be applied to an electronic device that receives video data being imaged by means of an imaging camera and displays the video data on a display unit in real time. For example, in the medical front, video of a currently-performed operation may be displayed on a display unit while enlarged images of a plurality of diseased parts are paused and displayed on the display unit.

The above-described operations of the electronic device may be executed by a circuit provided in the controller 110 or executed by reading a program recorded in the ROM 1101 or the NVM 1103 by the CPU 1100.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a receiver to receive an instruction to display an enlarged image of an area including a desired object on a display;
a processor configured to:
extract and record a feature pattern of an object in video displayed on the display in response to the input of the instruction;
detect a position of the object in each video frame based on the recorded feature pattern;
determine the area including the object;
determine a position of an enlarged image of the area out of the area, the area determined based on the position of the object; and
generate and output a signal of the enlarged image.

2. The device of claim 1, wherein the enlarged image is displayed along an edge of a display screen or displayed at a predetermined position.

3. The device of claim 2, wherein the enlarged image is displayed at one of four corners of the display screen.

4. The device of claim 3, wherein the enlarged image is displayed at the farthest corner from the object.

5. The device of claim 1, wherein when a center point of the area or the object is positioned within a predetermined range, a display position of the enlarged image is fixed.

6. The device of claim 1, further comprising:
a frame memory which temporarily stores a video signal of the enlarged image; and
a sub-processor which controls a timing of reading the video signal stored in the frame memory,
wherein, a same frame including the enlarged image is continuously displayed or an updating frame is displayed at adjustable intervals.

7. An image processing method comprising:
receiving an input of an instruction to display an enlarged image of an area including a desired object on a display;
extracting and recording a feature pattern of an object in video displayed on the display in response to the input of the instruction;
detecting a position of the object in each video frame based on the recorded feature pattern;
determining the area including the object;
determining a position of the enlarged image of the area out of the area, the area determined based on the position of the object; and
generating and outputting a signal of the enlarged image.

8. The method of claim 7, wherein the enlarged image is displayed along an edge of a display screen or displayed at a predetermined position.

9. The method of claim 8, wherein the enlarged image is displayed at one of four corners of the display screen.

10. The method of claim 9, wherein the enlarged image is displayed at the farthest corner from the object.

11. The method of claim 7, wherein when a center point of the area or the object is positioned within a predetermined range, a display position of the enlarged image is fixed.

12. The method of claim 7, further comprising:
temporarily storing a video signal of the enlarged image; and
controlling a timing of reading the stored video signal, wherein, a same frame including the enlarged image is continuously displayed or an updating frame is displayed at an adjustable intervals.
